(19) United States
(12) Patent Application Publication
(10) Pub. No.: US 2026/0150164 A1
(43) Pub. Date: May 28, 2026

(54) MODULAR LIGHTING DEVICE WITH HIGH CONVERSION EFFICIENCY

(71) Applicant: Xiamen PVTECH Co., Ltd., Xiamen (CN)

(72) Inventors: LONGYIN CHEN, Xiamen (CN); FUXING LU, Xiamen (CN)

(21) Appl. No.: 19/334,926

(22) Filed: Sep. 21, 2025

(30) Foreign Application Priority Data
Sep. 24, 2024 (CN) 202411331684.3

(51) Int. Cl. H05B 45/345; H05B 45/46; H05B 45/54

(52) U.S. Cl. CPC H05B 45/345; H05B 45/46; H05B 45/54

(57) ABSTRACT

A modular lighting device includes a power supply module and a light source module. The power supply module includes an input unit connected to a constant-voltage power source and having positive and negative terminals. The light source module includes a first terminal, a second terminal, a plurality of light sources and a constant-current control unit. The constant-current control unit includes a driving switch, a control switch and a first resistor. The first and second terminals are connected to the positive and negative terminals. The light sources form a serial circuit having a power supply node connected to a first node and the first terminal. The driving switch is connected to the first node, the serial circuit, and a second node. The control switch is connected to the second node, first node, and second terminal. The first resistor is connected to the second node and second terminal.

### TECHNICAL FIELD

The disclosure relates to a lighting device, in particular to a modular lighting device with high conversion efficiency.

### BACKGROUND

Currently available downlights mainly adopt constant-current power supply chips for control, and each downlight requires a junction box for wiring operations. Therefore, the installation of the currently available downlights takes considerable time, which increases the installation costs of the currently available downlights.

In addition, most currently available downlights use linear chips with constant-current function to supply power to the light sources. Accordingly, the operating voltage of the linear chip must be taken into account in circuit design, and a voltage difference is also required between the power supply and the load, which increases power consumption and reduces conversion efficiency. As a result, the luminous efficiency of the currently available downlights is also reduced.

Therefore, how to provide a lighting device that addresses the above-mentioned problems of the prior art has become an urgent issue.

### SUMMARY

One embodiment of the disclosure, the modular lighting device with high conversion efficiency includes a power supply module and a light source module. The power supply module includes an input unit having a positive terminal and a negative terminal, and the input unit is connected to a constant-voltage power source. The light source module includes a first terminal, a second terminal, a plurality of light sources and a constant-current control unit. The constant-current control unit includes a driving switch, a control switch and a first resistor. The first terminal and the second terminal are respectively connected to the positive terminal and the negative terminal. The light sources are connected to each other in series to form a serial circuit having a power supply node. One end of the serial circuit is connected to the first terminal. The first end, the second end, and the third end of the driving switch are respectively connected to a first node, the other end of the serial circuit, and a second node. The first end, the second end, and the third end of the control switch are respectively connected to the second node, the first node, and the second terminal. Two ends of the first resistor are respectively connected to the second node and the second terminal, and the first node is connected to the power supply node.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a block diagram of a circuit structure of a modular lighting device with high conversion efficiency in accordance with a first embodiment of the disclosure.

FIG. 2 is a circuit diagram of a light source module of the modular lighting device with high conversion efficiency in accordance with the first embodiment of the disclosure.

FIG. 3 is a circuit diagram of a light source module of a modular lighting device with high conversion efficiency in accordance with a second embodiment of the disclosure.

FIG. 4 is a block diagram of a circuit structure of a modular lighting device with high conversion efficiency in accordance with a third embodiment of the disclosure.

FIG. 5 is a block diagram of a circuit structure of a modular lighting device with high conversion efficiency in accordance with a fourth embodiment of the disclosure.

FIG. 6 is a block diagram of a circuit structure of a modular lighting device with high conversion efficiency in accordance with a fifth embodiment of the disclosure.

FIG. 7 is a circuit diagram of a modular lighting device with high conversion efficiency in accordance with a sixth embodiment of the disclosure.

FIG. 8 is a circuit diagram of a modular lighting device with high conversion efficiency in accordance with a seventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

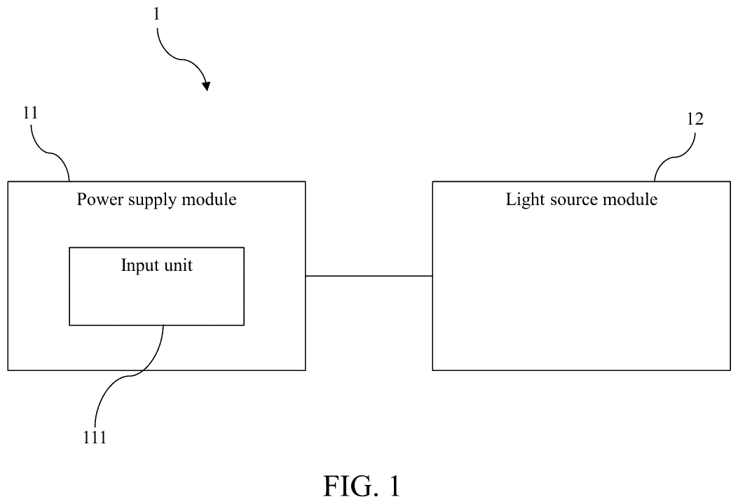

Please refer to FIG. 1, which is a block diagram of a circuit structure of a modular lighting device with high conversion efficiency in accordance with a first embodiment of the disclosure. As shown in FIG. 1, the modular lighting device 1 includes a power supply module 11 and a light source module 12. The power supply module 11 includes an input unit 111 having a positive terminal E+ and a negative terminal E−, and the input unit 111 is connected to a constant-voltage power source. The power supply module 11 is connected to the light source module 12. In one embodiment, the constant-voltage power source may be an adapter. In another embodiment, the constant-voltage power source may also be a battery or other currently available power sources.

The embodiment just exemplifies the disclosure and is not intended to limit the scope of the disclosure; any equivalent modification and variation according to the spirit of the disclosure is to be also included within the scope of the following claims and their equivalents.

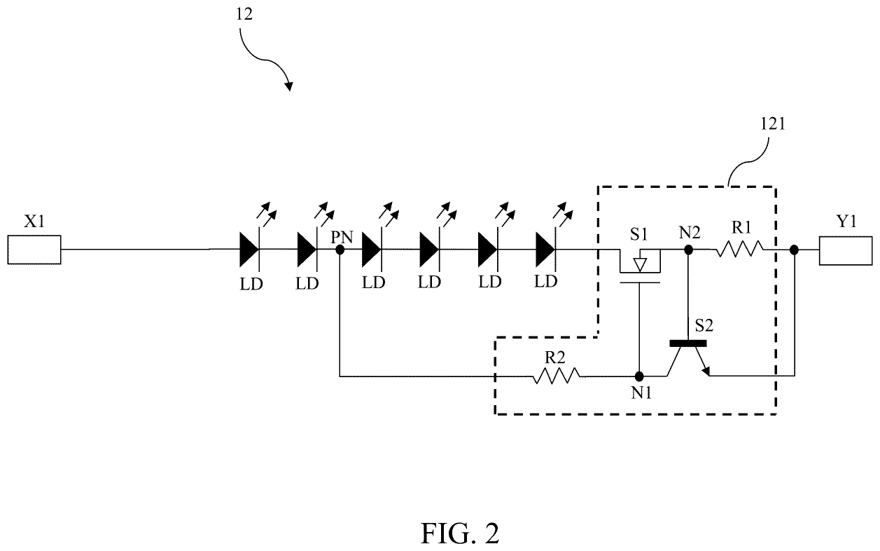

Please refer to FIG. 2, which is a circuit diagram of a light source module of the modular lighting device with high conversion efficiency in accordance with the first embodiment of the disclosure. This embodiment illustrates one of the possible circuit structures of the light source module 12. As shown in FIG. 2, the light source module 12 includes a first terminal X1, a second terminal Y1, a plurality of light sources LD, and a constant-current control unit 121. In this embodiment, the first terminal X1 is positive and the second terminal Y1 is negative. In another embodiment, the first terminal X1 may be negative and the second terminal Y1 may be positive.

The constant-current control unit 121 includes a driving switch S1, a control switch S2, a first resistor R1, and a second resistor R2. The first terminal X1 and the second terminal Y1 are connected to the power supply module 11 (the first terminal X1 and the second terminal Y1 are respectively connected to the positive terminal E+ and the negative terminal E− of the power supply module 11) to receive input current from the power supply module 11. The light sources LD are connected to each other in series to form a serial circuit having a power supply node PN. The power supply node PN is located between two adjacent light sources LD. One end of the serial circuit is connected to the first terminal X1. The first end of the driving switch S1 is connected to a first node N1, the second end of the driving switch S1 is connected to the other end of the serial circuit, and the third end of the driving switch S1 is connected to a second node N2. The first end of the control switch S2 is connected to the second node N2, the second end of the control switch S2 is connected to the first node N1, and the third end of the control switch S2 is connected to the second terminal Y1. Two ends of the first resistor R1 are connected to the second node N2 and the second terminal Y1, respectively. The first node N1 is connected to the power supply node PN via the second resistor R2. In this embodiment, the driving switch S1 is a metal-oxide-semiconductor field-effect transistor (MOSFET). The first end of the driving switch S1 is the gate, the second end is the drain, and the third end is the source. In another embodiment, the driving switch S1 may also be a bipolar junction transistor (BJT) or other similar components. In this embodiment, the control switch S2 is a BJT. The first end of the control switch S2 is the base, the second end is the emitter, and the third end is the collector. In another embodiment, the control switch S2 may also be a MOSFET or other similar components. In this embodiment, the light sources LD are LEDs. In another embodiment, the light sources LD may be LED arrays or other currently available light sources. The number of the light sources LD may be adjusted according to actual requirements, and the position of the power supply node PN may also be adjusted as needed to achieve optimal performance.

When the light source module 12 is activated, the driving switch S1 is not yet turned on, and no current flows through the serial circuit formed by the light sources LD. At this time, the voltage applied at the power supply node PN causes a voltage difference between the gate of the driving switch S1 and the ground GND, thereby turning on the driving switch S1. The resistance value of the driving switch S1 varies with the voltage to achieve current regulation and voltage regulation. The resistance value of the second resistor R2 is designed such that the driving switch S1 continuously operates in the ohmic region. When the conditions of Equations (1) and (2) are satisfied, the driving switch S1 may operate in the ohmic region, where Equations (1) and (2) are as follows:

$$Vgs > Vth \qquad ( 1 )$$

$$Vgs < Vgs - Vth \qquad ( 2 )$$

In Equations (1) and (2), Vgs stands for the gate-source voltage of the driving switch S1; Vth stands for the threshold voltage of the driving switch S1.

When the driving switch S1 operates in the ohmic region, Id (drain current) of the driving switch S1 increases with the increase of Vds (drain-source voltage) of the driving switch S1 (Id has a linear relationship with Vds). In addition, when Vgs of the driving switch S1 changes, the resistance value of Rds (drain-source resistor) of the driving switch S1 also changes.

When no current flows through the serial circuit, the control switch S2 is in the off state. When current flows through the serial circuit, the voltage across the first resistor R1 gradually increases to a reference voltage (e.g., 0.5V), thereby turning on the control switch S2 and forming the reference voltage. The resistance value of the first resistor R1 is designed such that the serial circuit continuously operates in the constant-current state. In addition, the emitter current of the control switch S2 is greater than zero, and the collector current of the control switch S2 is limited by the second resistor R2, thereby keeping the control switch S2 operating in the active region.

The resistance value of the first resistor R1 is given by Equation (3):

$$Rm 1 = Vsd / Cw \qquad ( 3 )$$

In Equation (3), Rm1 stands for the resistance value of the first resistor R1; Vsd stands for the reference voltage, and Cw stands for the operating current of the serial circuit.

The resistance value of the second resistor R2 is given by Equation (4):

$$Rm 2 = Vdiodes - Vg - Vbe / It \qquad ( 4 )$$

In Equation (4), Rm2 stands for the resistance value of the second resistor R2; Vdiodes stands for the serial voltage of four light sources LD (in this embodiment, the power supply node PN is set between two light source groups, one group including two light sources LD and the other group including four light sources LD); Vg stands for the gate voltage of the driving switch S1; Vbe stands for the base-emitter voltage of the control switch S2; It stands for the current that keeps the control switch S2 operating in the active region.

Through the above circuit design and operating mechanism, the light source module 12 can form the serial circuit with the power supply node PN and supply power to the driving switch S1 of the constant-current control unit 121 via the power supply node PN. In this way, the constant-current control unit 121 does not need to be powered by the constant-voltage power source or an operating voltage source, nor does it require a voltage regulator diode or a voltage divider resistor, thereby significantly reducing power loss. Therefore, the conversion efficiency of the constant-current control unit 121 can be greatly improved, and the luminous efficiency of the modular lighting device 1 is also significantly enhanced.

The embodiment just exemplifies the disclosure and is not intended to limit the scope of the disclosure; any equivalent modification and variation according to the spirit of the disclosure is to be also included within the scope of the following claims and their equivalents.

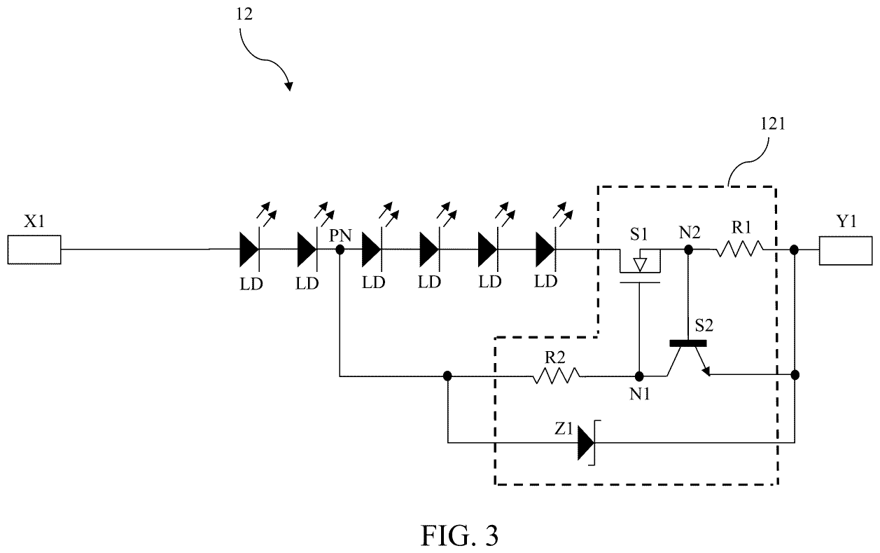

Please refer to FIG. 3, which is a circuit diagram of a light source module of a modular lighting device with high conversion efficiency in accordance with a second embodiment of the disclosure. This embodiment illustrates another of the possible circuit structures of the light source module 12. As shown FIG. 3, the light source module 12 includes a first terminal X1, a second terminal Y1, a plurality of light sources LD, and a constant-current control unit 121. The constant-current control unit 121 comprises a driving switch S1, a control switch S2, a first resistor R1, and a second resistor R2.

The components described above are the same as those of the previous embodiment and will not be described again. Different from the previous embodiment, the constant-current control unit 121 of this embodiment further comprises a Zener diode Z1. Two ends of the Zener diode Z1 are connected to the power supply node PN and the second terminal Y1, respectively.

Similarly, through the above circuit design, the light source module 12 can form a serial circuit with the power supply node PN and supply power to the driving switch S1 of the constant-current control unit 121 via the power supply node PN. In this way, the constant-current control unit 121 does not need to be powered by the constant-voltage power source or an operating voltage source, nor does it require a voltage regulator diode or a voltage divider resistor, thereby significantly reducing power loss. Therefore, the conversion efficiency of the constant-current control unit 121 can be greatly improved, and the luminous efficiency of the modular lighting device 1 is also significantly enhanced.

The embodiment just exemplifies the disclosure and is not intended to limit the scope of the disclosure; any equivalent modification and variation according to the spirit of the disclosure is to be also included within the scope of the following claims and their equivalents.

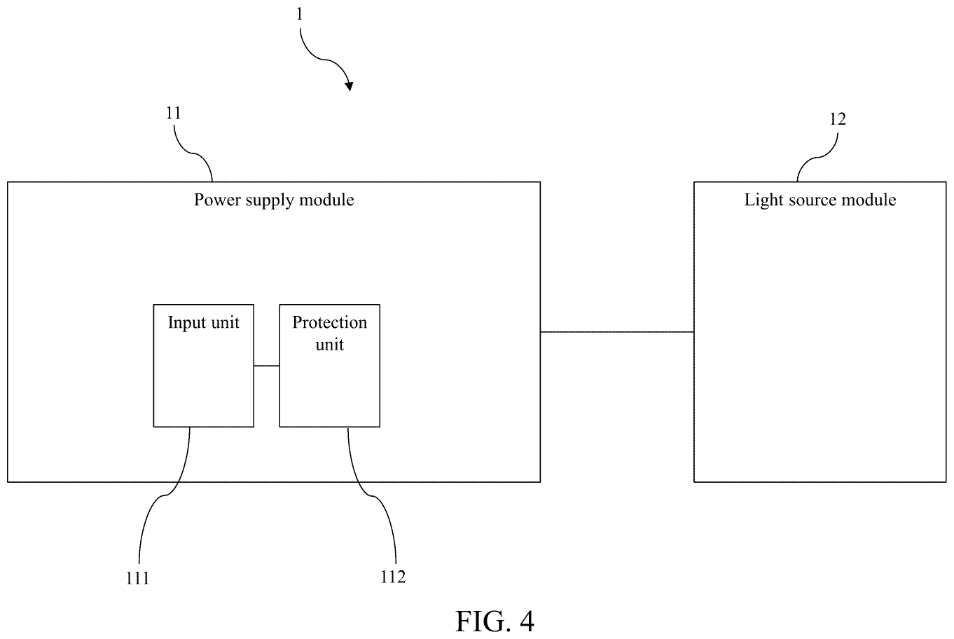

Please refer to FIG. 4, which is a block diagram of a circuit structure of a modular lighting device with high conversion efficiency in accordance with a third embodiment of the disclosure, and also refer to FIG. 1 or FIG. 2. As shown in FIG. 4, the modular lighting device 1 includes a power supply module 11 and a light source module 12. The power supply module 11 includes an input unit 111 having a positive terminal E+ and a negative terminal E−. The input unit 111 is connected to a constant-voltage power source.

The components described above are the same as those of the previous embodiments and will not be described again. The difference between this embodiment and the previous embodiments is that the power supply module 11 of this embodiment further includes a protection unit 112. The positive terminal E+ and the negative terminal E− of the power supply module 11 are respectively connected to the first terminal X1 and the second terminal Y1 of the light source module 12 via the protection unit 112. The protection unit 112 may include a transient voltage suppressor (TVS) diode J1 to provide overvoltage protection.

As previously stated, the protection unit 112 can effectively suppress transient voltage and provide the modular lighting device 1 with the overvoltage protection function. Therefore, the reliability of the modular lighting device 1 can be greatly improved to meet actual requirements.

The embodiment just exemplifies the disclosure and is not intended to limit the scope of the disclosure; any equivalent modification and variation according to the spirit of the disclosure is to be also included within the scope of the following claims and their equivalents.

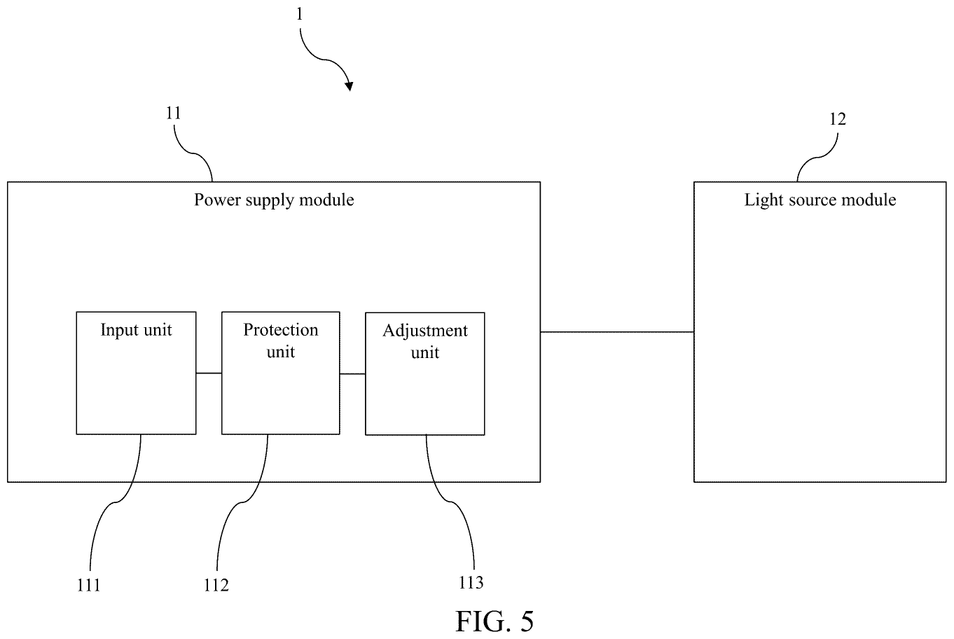

Please refer to FIG. 5, which is a block diagram of a circuit structure of a modular lighting device with high conversion efficiency in accordance with a fourth embodiment of the disclosure, and also refer to FIG. 1 or FIG. 2. As shown in FIG. 5, the modular lighting device 1 includes a power supply module 11 and a light source module 12. The power supply module 11 includes an input unit 111 having a positive terminal E+ and a negative terminal E− and a protection unit 112. The input unit 111 is connected to a constant-voltage power source.

The components described above are the same as those of the previous embodiments and will not be described again. The difference between this embodiment and the previous embodiments is that the power supply module 11 of this embodiment further includes an adjustment unit 113. The positive terminal E+ and the negative terminal E− of the power supply module 11 are connected to the protection unit 112. The protection unit 112 is connected to the first terminal X1 and the second terminal Y1 of the light source module 12 via the adjustment unit 113. The adjustment unit 113 includes an adjustment capacitor Ca and a protection resistor Rp to provide the brightness adjustment and overcurrent protection functions.

As described above, the modular lighting device 1 can achieve the gradual lighting start-up function through the adjustment capacitor Ca, allowing the lighting function of the modular lighting device 1 to provide users with a better user experience. In addition, the adjustment unit 113 can effectively suppress transient current and provide the modular lighting device 1 with the overcurrent protection function. Therefore, the reliability of the modular lighting device 1 can be further improved to meet actual requirements.

The embodiment just exemplifies the disclosure and is not intended to limit the scope of the disclosure; any equivalent modification and variation according to the spirit of the disclosure is to be also included within the scope of the following claims and their equivalents.

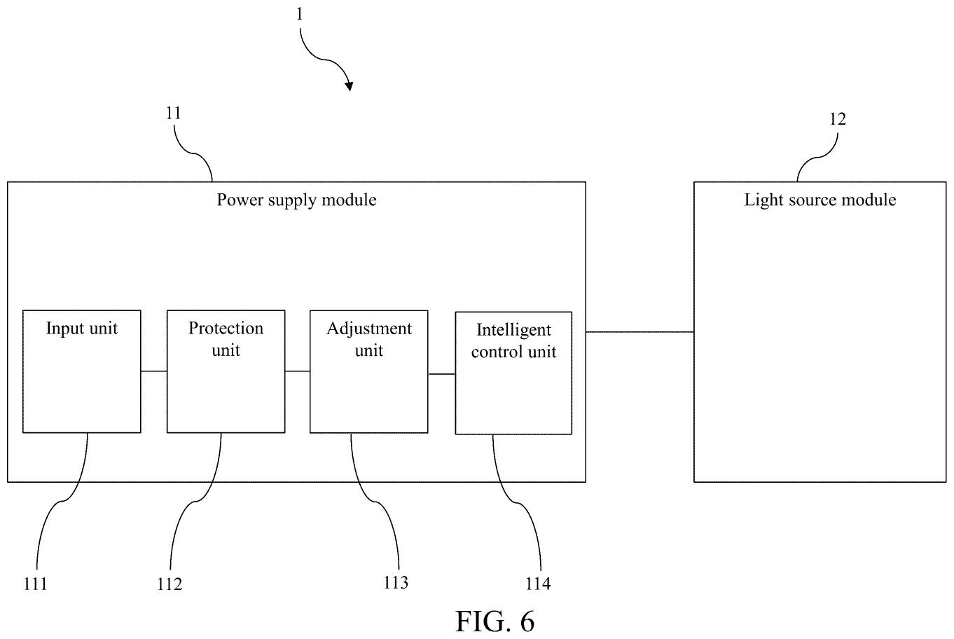

Please refer to FIG. 6, which is a block diagram of a circuit structure of a modular lighting device with high conversion efficiency in accordance with a fifth embodiment of the disclosure, and also refer to FIG. 1 or FIG. 2. As shown in FIG. 6, the modular lighting device 1 includes a power supply module 11 and a light source module 12. The power supply module 11 includes an input unit 111 having a positive terminal E+ and a negative terminal E−, a protection unit 112, and an adjustment unit 113. The input unit 111 is connected to a constant-voltage power source.

The above components are the same as those in the foregoing embodiments, and thus will not be further described herein. The difference between this embodiment and the previous embodiments is that the power supply module 11 of this embodiment further includes an intelligent control unit 114. The positive terminal E+ and the negative terminal E− of the power supply module 11 are connected to the protection unit 112. The protection unit 112 is connected to the adjustment unit 113. The adjustment unit 113 is connected to the intelligent control unit 114. The intelligent control unit 114 is connected to the first terminal X1 and the second terminal Y1 of the light source module 12.

As set forth above, the user may transmit a lighting mode adjustment signal via an electronic device (such as a smart phone, tablet computer, notebook computer, etc.) to adjust the brightness and/or color temperature of the light source module 12. Therefore, the use of the modular lighting device 1 is more convenient and can meet the needs of different users.

In addition, multiple functional modules and functional units of the modular lighting device 1 adopt a modular design, such that one power supply module 11 can be connected to multiple light source modules 12. Furthermore, the power supply module 11 of the modular lighting device 1 may achieve power systematization. Therefore, the installation cost of the modular lighting device 1 can be significantly reduced to meet the requirements of different applications.

Moreover, the modular lighting device 1 includes the intelligent control unit 114 to realize various intelligent control functions. Thus, the modular lighting device 1 may be applied to various currently available intelligent systems (such as smart home systems, smart parking systems, etc.). Therefore, the modular lighting device 1 can be more comprehensive in application and can meet the future development trends.

The embodiment just exemplifies the disclosure and is not intended to limit the scope of the disclosure; any equivalent modification and variation according to the spirit of the disclosure is to be also included within the scope of the following claims and their equivalents.

It is worthy to point out that currently available downlights mainly adopt constant-current power supply chips for control, and each downlight requires a junction box for wiring operations. Therefore, the installation of the currently available downlights takes considerable time, which increases the installation costs of the currently available downlights. In addition, most currently available downlights use linear chips with constant-current function to supply power to the light sources. Accordingly, the operating voltage of the linear chip must be taken into account in circuit design, and a voltage difference is also required between the power supply and the load, which increases power consumption and reduces conversion efficiency. As a result, the luminous efficiency of the currently available downlights is also reduced. By contrast, according to one embodiment of the disclosure, a modular lighting device 1 includes a power supply module 11 and a light source module 12. The power supply module 11 includes an input unit 111 having a positive terminal E+ and a negative terminal E−, and the input unit 111 is connected to a constant-voltage power source. The light source module 12 includes a first terminal X1, a second terminal Y1, a plurality of light sources LD, and a constant-current control unit 121. The constant-current control unit 121 includes a driving switch S1, a control switch S2, and a first resistor R1. The first terminal X1 and the second terminal Y1 are respectively connected to the positive terminal E+ and the negative terminal E−. The light sources LD are connected to each other in series to form a serial circuit having a power supply node PN, and one end of the serial circuit is connected to the first terminal X1. The first end, the second end, and the third end of the driving switch S1 are respectively connected to a first node N1, the other end of the serial circuit, and a second node N2. The first end, the 0second end, and the third end of the control switch S2 are respectively connected to the second node N2, the first node N1, and the second terminal Y1. Two ends of the first resistor R1 are respectively connected to the second node N2 and the second terminal Y1. The first node N1 is connected to the power supply node PN. The power supply node PN is located between two adjacent light sources LD. As set forth above, the light source module 12 can form a serial circuit with the power supply node PN and supply power to the driving switch S1 of the constant-current control unit 121 through the power supply node PN. In this way, the constant-current control unit 121 does not need to be powered via the constant-voltage power source or an operating voltage source, and does not require a voltage regulator diode or a voltage divider resistor, which can greatly reduce power loss. Therefore, the conversion efficiency of the constant-current control unit 121 can be significantly improved, and the luminous efficiency of the modular lighting device 1 is also greatly enhanced.

According to one embodiment of the disclosure, the power supply module 11 further comprises a protection unit 112. The positive terminal E+ and the negative terminal E− are respectively connected to the first terminal X1 and the second terminal Y1 via the protection unit 112. The protection unit 112 includes a transient voltage suppressor diode J1 to provide overvoltage protection. Thus, the protection unit 112 can effectively suppress transient voltage and provide the modular lighting device 1 with the overvoltage protection function. Therefore, the reliability of the modular lighting device 1 can be greatly improved to meet actual requirements.

Also, according to one embodiment of the disclosure, the modular lighting device 1 further includes an adjustment unit 113. The positive terminal E+ and the negative terminal E− are connected to the protection unit 112, and the protection unit 112 is connected to the first terminal X1 and the second terminal Y1 via the adjustment unit 113. The adjustment unit 113 includes an adjustment capacitor Ca to provide brightness adjustment. Therefore, the modular lighting device 1 can achieve the gradual lighting start-up function through the adjustment capacitor Ca, such that the lighting function of the modular lighting device 1 can provide users with a better experience.

In addition, according to one embodiment of the disclosure, the adjustment unit 113 of the modular lighting device 1 further includes a protection resistor Rp to provide overcurrent protection. In this way, the adjustment unit 113 can effectively suppress transient current and provide the modular lighting device 1 with the overcurrent protection function. Therefore, the reliability of the modular lighting device 1 can be further improved to meet practical application requirements.

Further, according to one embodiment of the disclosure, the modular lighting device 1 further comprises an intelligent control unit 114. The positive terminal E+ and the negative terminal E− are connected to the protection unit 112. The protection unit 112 is connected to the adjustment unit 113. The adjustment unit 113 is connected to the intelligent control unit 114. The intelligent control unit 114 is connected to the first terminal X1 and the second terminal Y1. The intelligent control unit 114 receives a lighting mode adjustment signal and adjusts the lighting mode of the light source module 12 according to the lighting mode adjustment signal. Thus, the user may transmit the lighting mode adjustment signal via an electronic device (such as a smart phone, tablet, or laptop computer) to adjust the brightness and/or color temperature of the light source module 12. Therefore, the modular lighting device 1 can be more convenient in use and can meet the needs of different users.

Moreover, according to one embodiment of the disclosure, the functional modules and functional units of the modular lighting device 1 are all designed in a modular manner, such that one power supply module 11 can be connected to multiple light source modules 12. In addition, the power supply module 11 of the modular lighting device 1 can achieve power systematization. Therefore, the installation cost of the modular lighting device 1 can be greatly reduced to meet the requirements of different applications.

Furthermore, according to one embodiment of the disclosure, the modular lighting device 1 comprises the intelligent control unit 114 to realize various intelligent control functions. Thus, the modular lighting device 1 can be applied to various currently available intelligent systems (such as smart home systems, smart parking systems, etc.). Therefore, the modular lighting device 1 can be more comprehensive in application and meet future development trends. As described above, the modular lighting device 1 according to the embodiments of the disclosure can definitely achieve great technical effects.

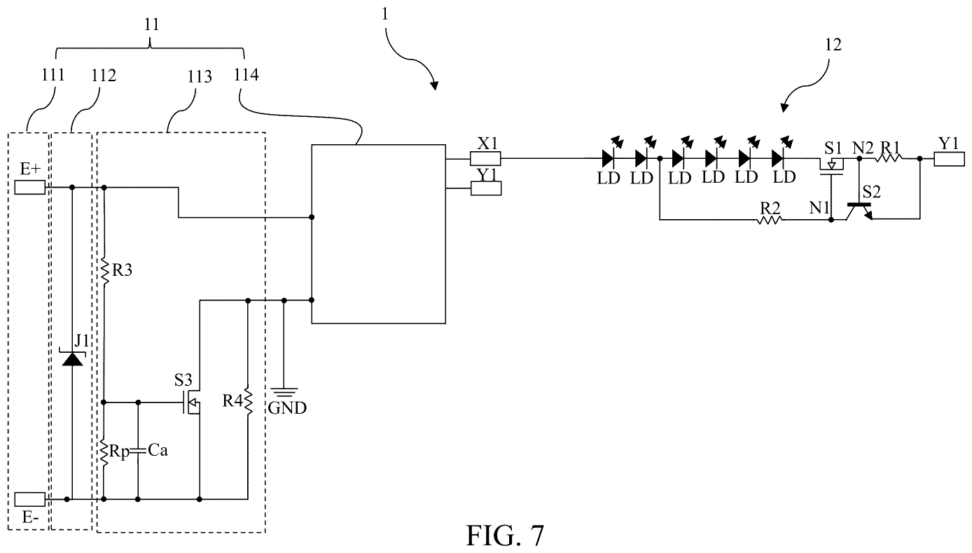

Please refer to FIG. 7, which is a circuit diagram of a modular lighting device with high conversion efficiency in accordance with a sixth embodiment of the disclosure. This embodiment illustrates one of the possible circuit structures of the modular lighting device 1. As shown in FIG. 7, the modular lighting device 1 includes a power supply module 11 and a light source module 12. The power supply module 11 includes an input unit 111 having a positive terminal E+ and a negative terminal E−, and the input unit 111 is connected to a constant-voltage power source.

The light source module 12 includes a first terminal X1, a second terminal Y1, a plurality of light sources LD, and a constant-current control unit 121. The circuit structure of the light source module 12 is the same as that of the first embodiment and is not further described herein.

The input unit 111 is connected to the protection unit 112. The protection unit 112 includes a transient voltage suppressor diode J1. The two terminals of the transient voltage suppressor diode J1 are respectively connected to the positive terminal E+ and the negative terminal E− of the input unit 111. The protection unit 112 can effectively suppress transient voltages to provide overvoltage protection for the modular lighting device 1. Therefore, the reliability of the modular lighting device 1 can be significantly improved to meet practical application requirements.

The adjustment unit 113 is connected to the protection unit 112. The adjustment unit 113 includes a third resistor R3, a fourth resistor R4, a protection resistor Rp, an adjustment capacitor Ca, and a third switch Q3 (GND stands for the grounding point). The capacitance value of the adjustment capacitor Ca is related to the brightness adjustment function, and the user may design the capacitance value of the adjustment capacitor Ca to achieve the gradual lighting start-up function. The resistance value of the protection resistor Rp is related to the overcurrent protection function, and the user may design the resistance value of the protection resistor Rp to achieve the overcurrent protection function. In this way, the modular lighting device 1 can provide a good user experience. In addition, the adjustment unit 113 can effectively suppress transient currents, providing overcurrent protection for the modular lighting device 1. Therefore, the reliability of the modular lighting device 1 can be further improved to meet practical application requirements.

The intelligent control unit 114 is connected to the adjustment unit 113 and also connected to the first terminal X1 and the second terminal Y1 of the light source module 12. The intelligent control unit 114 may include a control circuit and a communication circuit. The control circuit may be a microcontroller (MCU), central processing unit (CPU), application-specific integrated circuit (ASIC), field-programmable gate array (FPGA), or other similar components. The communication circuit may be a WiFi™ module, Bluetooth™ module, ZigBee™ module, or other similar components. The user can transmit a lighting mode adjustment signal via an electronic device (such as a smart phone, tablet computer, or notebook computer) to adjust the brightness and/or color temperature of the light source module 12. Therefore, the modular lighting device 1 can be more convenient in use and can meet the needs of different users. The modular lighting device 1 can be applied to various currently available intelligent systems (such as smart home systems, smart parking systems, etc.). Therefore, the modular lighting device 1 can be more comprehensive in application and meet future development trends.

Similarly, the light source module 12 can form a serial circuit having a power supply node PN and supply power to the driving switch S1 of the constant-current control unit 121 via the power supply node PN. Thus, the constant-current control unit 121 does not need to be powered through a constant-voltage power source or an operating voltage source, nor does it require a voltage regulator or a voltage divider resistor. This can significantly reduce power loss. Therefore, the conversion efficiency of the constant-current control unit 121 can be greatly improved, and the luminous efficiency of the modular lighting device 1 can also be significantly enhanced.

The embodiment just exemplifies the disclosure and is not intended to limit the scope of the disclosure; any equivalent modification and variation according to the spirit of the disclosure is to be also included within the scope of the following claims and their equivalents.

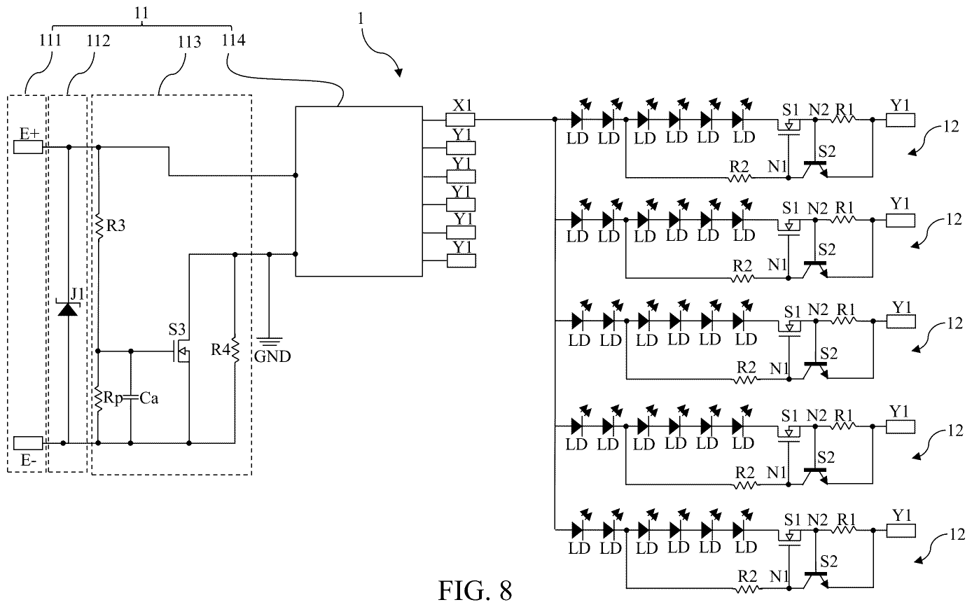

Please refer to FIG. 8, which is a circuit diagram of a modular lighting device with high conversion efficiency in accordance with a seventh embodiment of the disclosure. This embodiment illustrates another of the possible circuit structures of the modular lighting device 1. As shown in FIG. 8, the difference between this embodiment and the previous embodiments is that the modular lighting device 1 includes a plurality of light source modules 12. These light source modules 12 share one first terminal X1.

As can be understood from the above, the functional modules and functional units of the modular lighting device 1 adopt a modular design, allowing one power supply module 11 to connect to multiple light source modules 12. Furthermore, the power supply module 11 of the modular lighting device 1 may achieve power systematization. Therefore, the installation cost of the modular lighting device 1 can be significantly reduced to meet the requirements of different applications.

Similarly, each light source module 12 can form a serial circuit having a power supply node PN and supply power to the driving switch S1 of the constant-current control unit 121 through the power supply node PN. Thus, the constant-current control unit 121 does not require a constant-voltage power source or an operating voltage source for power supply, nor does it require a voltage regulator or a voltage divider resistor. This can greatly reduce power loss. Therefore, the conversion efficiency of the constant-current control unit 121 can be significantly improved, and the luminous efficiency of the modular lighting device 1 can also be greatly enhanced.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the disclosure, a modular lighting device 1 includes a power supply module 11 and a light source module 12. The power supply module 11 includes an input unit 111 having a positive terminal E+ and a negative terminal E−, and the input unit 111 is connected to a constant-voltage power source. The light source module 12 includes a first terminal X1, a second terminal Y1, a plurality of light sources LD, and a constant-current control unit 121. The constant-current control unit 121 includes a driving switch S1, a control switch S2, and a first resistor R1. The first terminal X1 and the second terminal Y1 are respectively connected to the positive terminal E+ and the negative terminal E−. The light sources LD are connected to each other in series to form a serial circuit having a power supply node PN, and one end of the serial circuit is connected to the first terminal X1. The first end, the second end, and the third end of the driving switch S1 are respectively connected to a first node N1, the other end of the serial circuit, and a second node N2. The first end, the 0second end, and the third end of the control switch S2 are respectively connected to the second node N2, the first node N1, and the second terminal Y1. Two ends of the first resistor R1 are respectively connected to the second node N2 and the second terminal Y1. The first node N1 is connected to the power supply node PN. The power supply node PN is located between two adjacent light sources LD. As set forth above, the light source module 12 can form a serial circuit with the power supply node PN and supply power to the driving switch S1 of the constant-current control unit 121 through the power supply node PN. In this way, the constant-current control unit 121 does not need to be powered via the constant-voltage power source or an operating voltage source, and does not require a voltage regulator diode or a voltage divider resistor, which can greatly reduce power loss. Therefore, the conversion efficiency of the constant-current control unit 121 can be significantly improved, and the luminous efficiency of the modular lighting device 1 is also greatly enhanced.

According to one embodiment of the disclosure, the power supply module 11 further comprises a protection unit 112. The positive terminal E+ and the negative terminal E− are respectively connected to the first terminal X1 and the second terminal Y1 via the protection unit 112. The protection unit 112 includes a transient voltage suppressor diode J1 to provide overvoltage protection. Thus, the protection unit 112 can effectively suppress transient voltage and provide the modular lighting device 1 with the overvoltage protection function. Therefore, the reliability of the modular lighting device 1 can be greatly improved to meet actual requirements.

Also, according to one embodiment of the disclosure, the modular lighting device 1 further includes an adjustment unit 113. The positive terminal E+ and the negative terminal E− are connected to the protection unit 112, and the protection unit 112 is connected to the first terminal X1 and the second terminal Y1 via the adjustment unit 113. The adjustment unit 113 includes an adjustment capacitor Ca to provide brightness adjustment. Therefore, the modular lighting device 1 can achieve the gradual lighting start-up function through the adjustment capacitor Ca, such that the lighting function of the modular lighting device 1 can provide users with a better experience.

In addition, according to one embodiment of the disclosure, the adjustment unit 113 of the modular lighting device 1 further includes a protection resistor Rp to provide overcurrent protection. In this way, the adjustment unit 113 can effectively suppress transient current and provide the modular lighting device 1 with the overcurrent protection function. Therefore, the reliability of the modular lighting device 1 can be further improved to meet practical application requirements.

Further, according to one embodiment of the disclosure, the modular lighting device 1 further comprises an intelligent control unit 114. The positive terminal E+ and the negative terminal E− are connected to the protection unit 112. The protection unit 112 is connected to the adjustment unit 113. The adjustment unit 113 is connected to the intelligent control unit 114. The intelligent control unit 114 is connected to the first terminal X1 and the second terminal Y1. The intelligent control unit 114 receives a lighting mode adjustment signal and adjusts the lighting mode of the light source module 12 according to the lighting mode adjustment signal. Thus, the user may transmit the lighting mode adjustment signal via an electronic device (such as a smart phone, tablet, or laptop computer) to adjust the brightness and/or color temperature of the light source module 12. Therefore, the modular lighting device 1 can be more convenient in use and can meet the needs of different users.

Moreover, according to one embodiment of the disclosure, the functional modules and functional units of the modular lighting device 1 are all designed in a modular manner, such that one power supply module 11 can be connected to multiple light source modules 12. In addition, the power supply module 11 of the modular lighting device 1 can achieve power systematization. Therefore, the installation cost of the modular lighting device 1 can be greatly reduced to meet the requirements of different applications.

Furthermore, according to one embodiment of the disclosure, the modular lighting device 1 comprises the intelligent control unit 114 to realize various intelligent control functions. Thus, the modular lighting device 1 can be applied to various currently available intelligent systems (such as smart home systems, smart parking systems, etc.). Therefore, the modular lighting device 1 can be more comprehensive in application and meet future development trends.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A modular lighting device with high conversion efficiency, comprising:
a power supply module comprising an input unit having a positive terminal and a negative terminal, the input unit being connected to a constant-voltage power source; and
a light source module comprising a first terminal, a second terminal, a plurality of light sources, and a constant-current control unit, the constant-current control unit comprising a driving switch, a control switch, and a first resistor;
wherein the first terminal and the second terminal are respectively connected to the positive terminal and the negative terminal, and the light sources are connected in series to form a serial circuit having a power supply node, and one end of the serial circuit is connected to the first terminal, wherein a first end, a second end, and a third end of the driving switch are respectively connected to a first node, another end of the serial circuit, and a second node, wherein a first end, a second end, and a third end of the control switch are respectively connected to the second node, the first node, and the second terminal, wherein two ends of the first resistor are respectively connected to the second node and the second terminal, and the first node is connected to the power supply node.

2. The modular lighting device with high conversion efficiency as claimed in claim 1, wherein the power supply node is located between two light sources adjacent thereto.

3. The modular lighting device with high conversion efficiency as claimed in claim 1, wherein the constant-current control unit further comprises a second resistor, and the first node is connected to the power supply node through the second resistor.

4. The modular lighting device with high conversion efficiency as claimed in claim 1, wherein the power supply module further comprises a protection unit, and the positive terminal and the negative terminal are respectively connected to the first terminal and the second terminal via the protection unit.

5. The modular lighting device with high conversion efficiency as claimed in claim 4, wherein the protection unit comprises a transient voltage suppressor diode configured to provide overvoltage protection.

6. The modular lighting device with high conversion efficiency as claimed in claim 4, wherein the power supply module further comprises an adjustment unit, the positive terminal and the negative terminal are connected to the protection unit, and the protection unit is connected to the first terminal and the second terminal via the adjustment unit.

7. The modular lighting device with high conversion efficiency as claimed in claim 6, wherein the adjustment unit comprises an adjustment capacitor configured to provide brightness adjustment.

8. The modular lighting device with high conversion efficiency as claimed in claim 7, wherein the adjustment unit further comprises a protection resistor configured to provide overcurrent protection.

9. The modular lighting device with high conversion efficiency as claimed in claim 6, wherein the power supply module further comprises an intelligent control unit, the positive terminal and the negative terminal are connected to the protection unit, the protection unit is connected to the adjustment unit, the adjustment unit is connected to the intelligent control unit, and the intelligent control unit is connected to the first terminal and the second terminal.

10. The modular lighting device with high conversion efficiency as claimed in claim 9, wherein the intelligent control unit is configured to receive a lighting mode adjustment signal so as to adjust a lighting mode of the light source module according to the lighting mode adjustment signal.
